(19) United States
(12) Patent Application Publication
(10) Pub. No.: US 2008/0189231 A1
(43) Pub. Date: Aug. 7, 2008

(54) Information Processing Device, Classification Reference Information Database, Information Generation Device, Information Processing Method, Information Generation Method, Information Processing Program, and Recording Medium Having Information Processing Program Recorded Therein

(75) Inventor: Naoaki Horiuchi, Saitama (JP)

Correspondence Address: KRATZ, QUINTOS & HANSON, LLP, 1420 K Street, N.W., Suite 400, WASHINGTON, DC, 20005, US

(73) Assignee: Pioneer Corporation, Tokyo (JP)

(21) Appl. No.: 11/665,681

(22) PCT Filed: Oct. 17, 2005
(86) PCT No.: PCT/JP2005/019018

§ 371 Date: Mar. 19, 2008

(30) Foreign Application Priority Data
Oct. 18, 2004 (JP) 2005-2004-303017

(51) Int. Cl. G06N 5/02

(52) U.S. Cl. 706/45

(57) ABSTRACT

A recording/reproduction system 100 operates a word retriever to retrieve a keyword from accumulated program information and operates a menu setting section to recognize the related word information KW related to the retrieved keyword and to generate menu index information based on the recognized related word information KW. A program classifier recognizes related number as related number information of content that relates to menu information Mi and classifies content of a program into menu information of the menu index information such that related number of programs related to each menu information Mi_n becomes substantially equal.

### TECHNICAL FIELD

The present invention relates to an information processing device that processes information, a classification criterion information database, an information generating device, an information processing method, an information generating method, an information processing program and a recording medium storing the information processing program.

### BACKGROUND ART

There have been conventionally known devices that receive EPG (Electric Program Guide) and automatically perform timer-recording and recording of a program based on a preset keyword. Such devices include a device that classifies recorded content into preset genres and classifies the recorded content into genres (see, for instance, Patent Document 1).

The device of Patent Document 1 includes a classification criterion information storage section that stores a classification criterion for classifying broadcast content that is received by a broadcast content receiving device or classifying recorded content into a plurality of categories. A program information classifier classifies acquired EPG based on the classification criterion stored in the classification criterion information storage section.

[Patent Document 1] JP-A-2000-36796 (left column of page 5 to left column of page 8, FIGS. 2 to 9).

### DISCLOSURE OF THE INVENTION

### Problems to be Solved by the Invention

In a related art arrangement as disclosed in Patent Document 1, the recorded content is classified based on the classification criterion stored in the classification criterion information storage section. With the arrangement, a classification criterion that meets a user's preference is apt to attract many pieces of recorded content while a classification criterion that does not meet the user's preference only attracts a few pieces of recorded content. Accordingly, it might be difficult to find predetermined recorded content desired by a user from a classification criterion that contains many pieces of recorded content.

An object of the present invention is to provide an information processing device, a classification criterion information database, an information generating device, an information processing method, an information generating method, an information processing program and a recording medium storing the information processing program that are capable of classifying information appropriately.

### Means for Solving the Problems

An information processing device according to an aspect of the present invention includes: a detail information acquirer that acquires detail information about a detail of information; a classification criterion acquirer that acquires classification criterion information about a classification criterion into which the information is classified; a related information number recognizer that recognizes related number of information related to the classification criterion information; and a classifier that classifies based on the detail of the detail information the information into the classification criterion information corresponding to the detail of the information such that the related number becomes substantially equal.

An information processing device according to another aspect of the present invention includes: a detail information acquirer that acquires detail information about a detail of information; a classification criterion acquirer that acquires classification criterion information with which plural pieces of criterion information are associated, the criterion information associated with detail criterion information about a classification criterion corresponding to the detail of the detail information and related number information about related number of the information related to the detail criterion information; a related information number recognizer that recognizes related number of the information based on the related number information; and a classifier that classifies the information into criterion information corresponding to the detail of the detail information and having the related number of equal to or smaller than a predetermined value in order to substantially equalize the related number of the information classified into the criterion information.

A classification criterion information database according to still another aspect of the present invention includes: plural pieces of classification criterion information that are structured in a table, each of the classification criterion information associated with plural pieces of criterion information, each of the criterion information associated with: detail criterion information about a classification criterion that corresponds to detail information about a detail of information and classifies the information; and related number information about related number of information related to the detail criterion information.

An information generating device according to yet another aspect of the present invention includes: a detail information recognizer that recognizes first detail information about a first detail of information and second detail information about a second detail related to the first detail of the first detail information; a related number information recognizer that recognizes related number information about related number of the information related to the first detail information; and a criterion information generator that generates first criterion information with which the first detail information and the related number information corresponding to the first detail information are associated; a classification criterion information generator that associates the first criterion information with second criterion information having the second detail information of the second detail related to the first detail of the first detail information of the first criterion information; and a data structuring section that structures the above-described classification information database of the present invention that contains the plural pieces of classification criterion information.

An information processing method according to further aspect of the invention includes: acquiring detail information about a detail of information; acquiring classification criterion information about a classification criterion into which the information is classified; recognizing related number of information related to the classification criterion information; and classifying based on the detail of the detail information the information into the classification criterion information corresponding to the detail of the information such that the related number becomes substantially equal.

An information generating method according to further aspect of the invention includes: recognizing first detail information about a first detail of information and second detail information about a second detail related to the first detail of the first detail information; recognizing related number information about related number of the information related to the first detail information; generating first criterion information with which the first detail information and the related number information corresponding to the first detail information are associated; associating the first criterion information with second criterion information having the second detail information of the second detail related to the first detail of the first detail information of the first criterion information; and structuring the above-described classification information database of the present invention that contains the plural pieces of the classification criterion information.

An information processing program according to further aspect of the present invention operates a computing section as the above-described information processing device of the present invention.

An information processing program according to further aspect of the present invention operates a computing section to perform the above-described information processing method of the present invention.

A recording medium according to further aspect of the present invention stores the above-described processing program in a manner readable by a computing section.

### BRIEF DESCRIPTION OF DRAWINGS

FIG. 1 is a block diagram showing an outline of a content recording/reproduction system according to an embodiment of the present invention;

FIG. 2 is a schematic diagram showing an outline of accumulated recorded program information;

FIG. 3 is a schematic diagram showing an outline of classification dictionary information;

FIG. 4 is a schematic diagram showing an outline of menu index information;

FIG. 5 is a schematic diagram showing an outline of a CPU (Central Processing Unit) of a recorder/reproducer;

FIG. 6A is a schematic diagram showing an example of a related word set including related word information;

FIG. 6B is a schematic diagram showing an example of how a menu setting section generates a broader word set including broader related word information;

FIG. 6C is a schematic diagram showing an example of how the menu setting section adds broader related word information corresponding to a related word set and deletes narrower related word information;

FIG. 6D is a schematic diagram showing an example of how the menu setting section generates menu information stored as a top menu item;

FIG. 7A is a schematic diagram showing an example of menu index information set by the menu setting section;

FIG. 7B is a schematic diagram showing an example of how a program classifier recognizes broader menu information and deletes menu information;

FIG. 8 is a schematic diagram showing an example of a program classification window;

FIG. 9 is a flowchart showing menu generation processing for generating menu information in classification/display processing in which content is classified into menus to be displayed; and

FIG. 10 is a flowchart showing classification processing for classifying the content in the classification/display processing in which the content is classified into the menus to be displayed.

### EXPLANATION OF CODES

200: a recorder/reproducer also serving as an information processing device and an information generating device
290: a CPU as a computing section
291: an accumulated recorded broadcast program recognizer as a detail information acquirer
292: a word retriever also serving as a dictionary recognizer and a detail information recognizer
293: a broadcast program number recognizer also serving as a related number information recognizer
294: a menu setting section also serving as a criterion information generator, a classification criterion information generator, a detail information set generator, a broader detail information judging section and a data structuring section
295: a broadcast program classifier also serving as a classification criterion acquirer, a related detail criterion information recognizer, a classifier, a related information number recognizer, a related number judging section, a broader criterion recognizer, a replacing section and a classifier
296: display controller
410: accumulated broadcast program information as detail information;
500: classification dictionary information as detail relation dictionary information
600: menu index information as a classification criterion information database
610: Mi: menu information as classification criterion information
650: related program information as information relation information
APS: average value
Mip: broader menu information as broader criterion information
Mi_n: narrower menu information as narrower criterion information
Mi_n_n: second narrower menu information as second narrower criterion information
KW: related word information as detail information
KWp: broader related word information as broader detail information
KWS: a related word set as detail set information
S: set value

### BEST MODE FOR CARRYING OUT THE INVENTION

An embodiment of the present invention will be described with reference to the attached drawings. In the present embodiment, a recorder/reproducer that includes an information generating device and an information processing device of the present invention will be exemplarily described. However, without limiting to such an arrangement, the present invention is applicable to a recorder dedicated for information recording, a standalone information processing device that operates a recorder or a recorder/reproducer to record information, an information processing device that controls reception (information acquisition) of a receiver of a television or the like that does not include a recording section and the like. In addition, processing in which content of a program (information) is acquired based on EPG (Electric Program Guide) which is distribution schedule information as program information of a program (detail information) will be exemplarily described in the present embodiment. However, without limiting to such an arrangement, the information may be content of a radio program, a satellite broadcast program, distributed music or video, etc., programs such as game software, various files recorded in a personal computer or the like when the information is acquired based on detail information about a detail of the information. In the following description, recording processing for acquiring information will be exemplified by recording of content, while information processing will be exemplified by reproduction of content.

[Arrangement of Content Recording/Reproduction System]

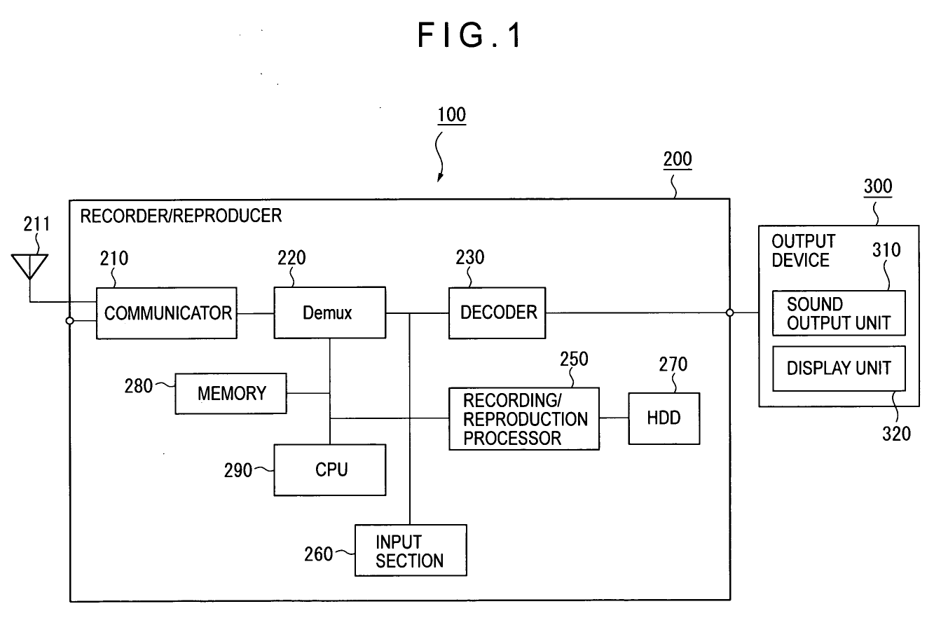

In FIG. 1, the reference numeral 100 denotes a content recording/reproduction system (hereinafter, referred to as a recording/reproduction system), which records content (information) such as a television program that includes sound information, video information, information-broadcasting information, etc. and reproduces the recorded content. The recording/reproduction system 100 includes a recorder/reproducer 200 and an output device 300.

The output device 300 includes a personal computer, a television, a mobile phone, a PHS (Personal Handyphone System) a PDA (Personal Digital Assistant) and the like. The output device 300 receives and outputs content output from the recorder/reproducer 200. The output device 300 includes a sound output unit 310 and a display unit 320.

The sound output unit 310 includes a sound generator such as a speaker (not shown). The sound output unit 310 vocalizes sound information transmitted as an analogue signal from the recorder/reproducer 200 through the sound generator. The sound generator may also output TV sound information received by a TV receiver (not shown) and the like.

The display unit 320 displays video information, broadcasting information, EPG information, video synthesis information, setting information and the like each transmitted from the recorder/reproducer 200 as an analogue signal. The video information to be displayed is exemplified by video of content. The broadcasting information is exemplified by a caption, information broadcast and the like of content. The EPG information is exemplified by a program list (electrical program guide) that contains a name, detail, broadcasting date and time etc. of content to be broadcasted on each channel. The video synthesis information exemplarily includes synthesized video in which a caption is superimposed on video of content and video in which the information broadcast and a program list are juxtaposed. The setting information may be exemplified by genre-selection video that prompts a user to select a genre of a program and a program list that is processed by the recorder/reproducer 200. The display unit 320 may be a liquid crystal display panel, an organic EL (ElectroLuminescence) panel, a PDP (Plasma Display Panel), a CRT (Cathode-Ray Tube), an FED (Field Emission Display), an electrophoretic display panel and the like. The display unit 320 may also output TV video information received by a TV receiver and the like.

The recorder/reproducer 200 acquires content having the sound information, the video information, the information-broadcasting information and the like which are distributed as TS (Transport Stream), the recorder/reproducer 200 recording the content and outputting the content from the output device 300. The recorder/reproducer 200 reproduces the recorded content and outputs the content from the output device 300. In addition, the recorder-reproducer 200 automatically deletes the content in a proper manner. The recorder/reproducer 200 includes a communicator 210, a Demultiplexer (Demux) 220, a decoder 230, a recording/reproduction processor 250, an input section 260, a hard disk drive (HDD) 270, a memory 280, a CPU (Central Processing Unit) 290 as a computing section and the like.

The communicator 210 acquires various information such as content input from the outside or outputs the various information such as the acquired content to the outside. The communicator 210 is connected to an antenna 211 for receiving broadcast waves of digital terrestrial broadcasting, satellite digital broadcasting and the like, the communicator 210 acquiring information transmitted as an analogue signal or a digital signal thorough the antenna 211, the information being, for instance, a TS that corresponds to content selected by a user from a plurality of TSs. The communicator 210 outputs the acquired TS to the Demux 220. The communicator 210 has, for instance, an interface of IEEE (Institute of Electrical and Electronic Engineers) 1394 standard capable of high-speed information processing. Through the interface, the communicator 210 acquires TS that is transmitted as a digital signal from an external device (not shown) provided outside of the recorder/reproducer 200 or a later-described partial TS and outputs the acquired TS or partial TS to the Demux 220. The communicator 210 also acquires the partial TS output from the recording/reproduction processor 250 and properly processes the acquired partial TS to be output as a digital signal to the external device (not shown) provided outside the recorder/reproducer 200.

The Demux 220 is connected to the decoder 230, the recording/reproduction processor 250 and the CPU 290. The Demux 220 acquires the TS from the communicator 210 and extracts a TS packet from the acquired TS to be output. Specifically, the Demux 220 acquires under the control of the CPU 290 a TS packet containing the sound information (hereinafter, referred to as a sound packet), a TS packet containing the video information (hereinafter, referred to as a video packet) and a TS packet that contains the information-broadcasting information or the EPG information as distribution information (hereinafter, referred to as an information packet). The Demux 220 outputs the acquired sound packet, video packet and information packet to the decoder 230. Upon acquiring the TS packets corresponding to content selected from the acquired TS, the Demux 220 reconstructs under the control of the CPU 290 the TS packets into a TS having an information sequence structure, namely a partial TS, and outputs the partial TS to the recording/reproduction processor 250. In addition, upon acquiring the partial TS from the communicator 210 or the recording/reproduction processor 250, the Demux 220 divides under the control of the CPU 290 the partial TS into the sound packet, the video packet and the information packet and outputs the packets to the decoder 230.

Meanwhile, the EPG information is information in which information about content such as a program of a TS acquirable by the communicator 210 is described in a text format such as BML (Broadcast Markup Language) and an XML (eXtensible Markup Language). Specifically, the EPG information has a single information structure in which a program description such as a name and a detail of a program, a broadcasting date and time, a broadcasting time period of the program, a channel, a genre and a series name are associated, which will be described later in detail.

The decoder 230 is connected to the Demux 220, the CPU 290 and the output device 300, the decoder 230 decoding the packets acquired from the Demux 220 to be output to the output device 300. Specifically, under the control of the CPU 290, the decoder 230 acquires the sound packet from the Demux 220 to decode sound information contained in the sound packet and outputs the decoded sound information as an analogue signal to the sound output unit 310 of the output device 300 acquires the video packet from the Demux 220 to decode video information contained in the video packet and outputs the decoded video information to the output device 300, and acquires the information packet from the Demux 220 to decode the information-broadcasting information or the EPG information contained in the information packet and outputs the decoded information to the output device 300. When the information packet contains the EPG information, the decoder 230 outputs the EPG information to the HDD 270 under the control of the CPU 290.

The recording/reproduction processor 250 is connected to the HDD 270, the CPU 290 and the like. The recording/reproduction processor 250 acquires the partial TS from the Demux 220 to store the partial TS in the HDD 270 and acquires the partial TS stored in the HDD 270 to output the partial TS to the communicator 210 or to the Demux 220.

The input section 260 is connected to the CPU 290 and the like. The input section 260 includes various operation buttons and operation knobs (each not shown) provided operably on a front surface of a casing (not shown). The operation buttons and the operation knobs are used, for instance, to input settings of operations of the recorder/reproducer 200. Specifically, the settings of operations include a setting regarding a genre selection for retrieving a desired program, a setting regarding recording or reproduction of content, a setting of a TS received by the communicator 210 and the like. The input section 260 also serves as a generator of later-described request information that requests retrieval, recording or reproduction of a program in accordance with input operation. Based on the input operation for the settings, the input section 260 transmits various information as an operation signal to the CPU 290 so as to apply the settings. The input section 260 may include a remote-control light receiver that receives various information transmitted via infrared rays from a remote controller (not shown) and transmits the various information as an operation signal to the CPU 290.

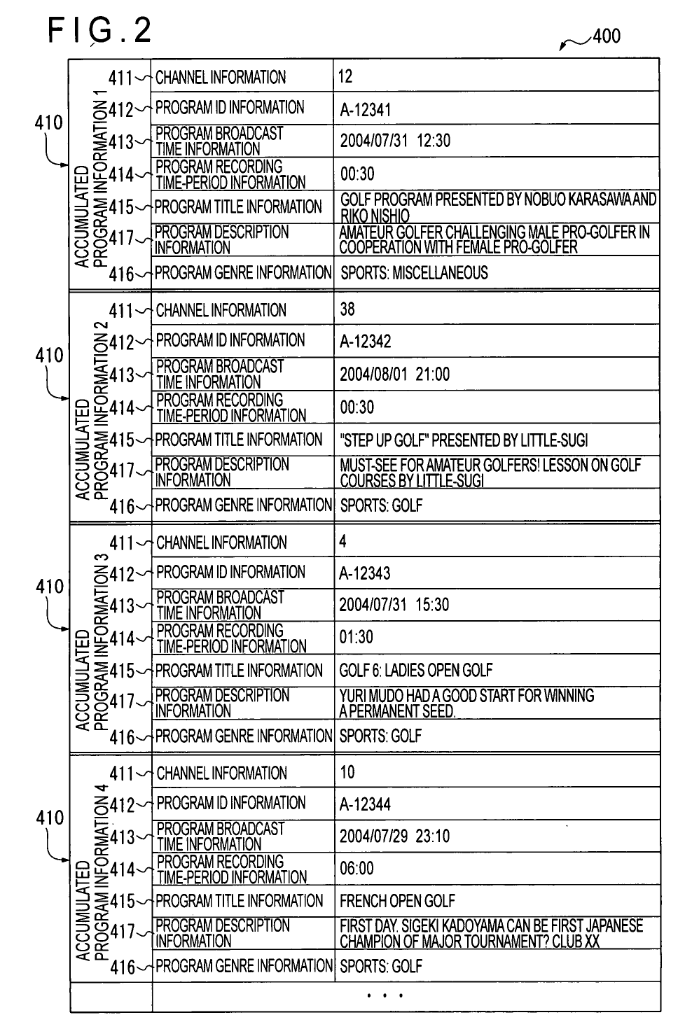

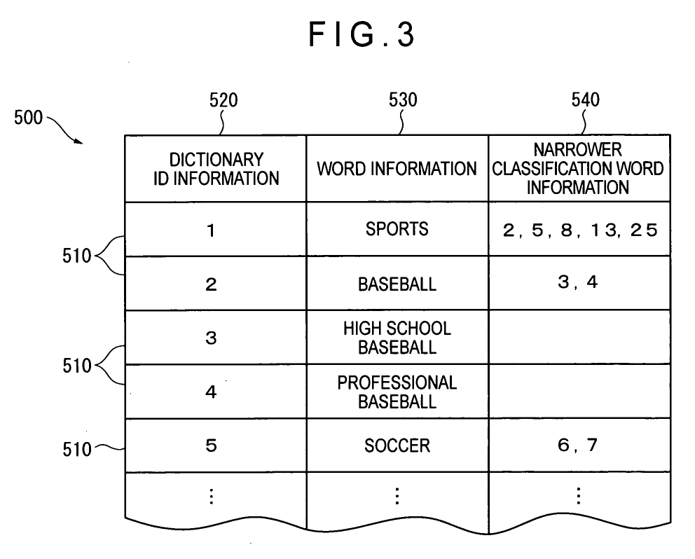

The HDD 270 is connected to the CPU 290 and the like. The HDD 270 is controlled by, for instance, ATA (AT Attachment) interface. Note that although the HDD 270 controlled by the ATA interface will be described, the HDD 270 may alternatively be controlled by IDE (Integrated Drive Electronics) interface, SCSI (Small Computer System Interface) and the like. In addition, the HDD 270 may be replaced by an arrangement including a drive or a driver that readably stores information in removable recording media such as an optical disc, a magnetooptical disc and a memory card or in a built-in memory. The HDD 270 readably stores the partial TS of the content input from the recording/reproduction processor 250, namely content, EPG information, etc. Specifically, the HDD 270 includes an information storage area (not shown) for storing the content, an EPG storage area (not shown) for storing the EPG information, an accumulated program storage area for storing accumulated recorded program information 400 (shown in FIG. 2) about recorded programs and a classification dictionary storage area for storing a classification dictionary 500 (shown in FIG. 3) as a detail relation dictionary information. Note that the information storage area, the EPG storage area, the accumulated program storage area and the classification dictionary storage area may be included in the memory 280.

The accumulated recorded program information 400 has a table structure in which plural pieces of accumulated program information 410 (detail information) about programs recorded in the HDD 270 are stored, the accumulated recorded program information 400 generated based on the EPG. The accumulated program information 410 is generated based on a recording time, a recorded channel and the like which are referenced when content is recorded in the HDD 270. As shown in FIG. 2, the accumulated program information 410 has a single data structure with which channel information 411, content number 412, program broadcast time information 413, program recording time-period information 414, program title information 415, program description information 416, program genre information 417 and the like are associated.

The channel information 411 is information about a channel on which a program is broadcasted. The channel information 411 is generated based on channel information in program information of the EPG. The channel information 411 is individually set for each area where the program is broadcasted.

The content number 412 is unique identifier for identifying content, which is assigned to content stored in the content storage area of the HDD 270. Note that information representing a name or the like uniquely assigned to the content may be employed instead of the content number 611.

The program broadcast time information 413 is information about a time at which the program is recorded. The program broadcast time information 413 contains a time and a date when the program is recorded.

The program recording time-period information 414 is information about a recording time period for which the program is recorded.

The program title information 415 is information about a name or a title of the program. The program title information 415 is generated based on program title information in the program information of the EPG. The program title information 415 contains the name or the title of the program in a text format.

The program description information 416 is information in which a simple description of broadcasting details of the program, an outline of the program or details of the program including individual names such as a performer, a director and a script writer is described in a text format. The program description information 416 is generated based on program description information in the program information of the EPG.

The program genre information 417 is information about to which genre a program falls into when programs are classified into genres based on details. The program genre information 417 is generated based on program genre information in the program information of the EPG. Examples of the genre include “variety show”, “drama”, “movie”, “press report”, “news and “sports”. The program genre information 417 may be associated with sub-genres, e.g., “golf”, “baseball” etc., for “sports”.

The classification dictionary 500 is a dictionary showing a relevance of a genre of the program, a keyword and the like. The classification dictionary 500 has a table structure containing plural pieces of dictionary information 510 that is constructed in a single data structure with which dictionary ID (Identifier) information 520, word information 530, narrower classification word information 540 are associated.

The dictionary ID information 520 is unique ID information for identifying each dictionary information 510. The word information 530 contains words representing a genre of the program, a keyword and the like. The narrower classification word information 540 contains dictionary information 510 that includes word information 530 containing a word of a narrower concept of the word contained in the word information 530. The narrower classification word information 540 contains, for instance, dictionary ID information 520 of subjected dictionary information 510. Note that the narrower classification word information 540 may directly contain the words of the narrower concept.

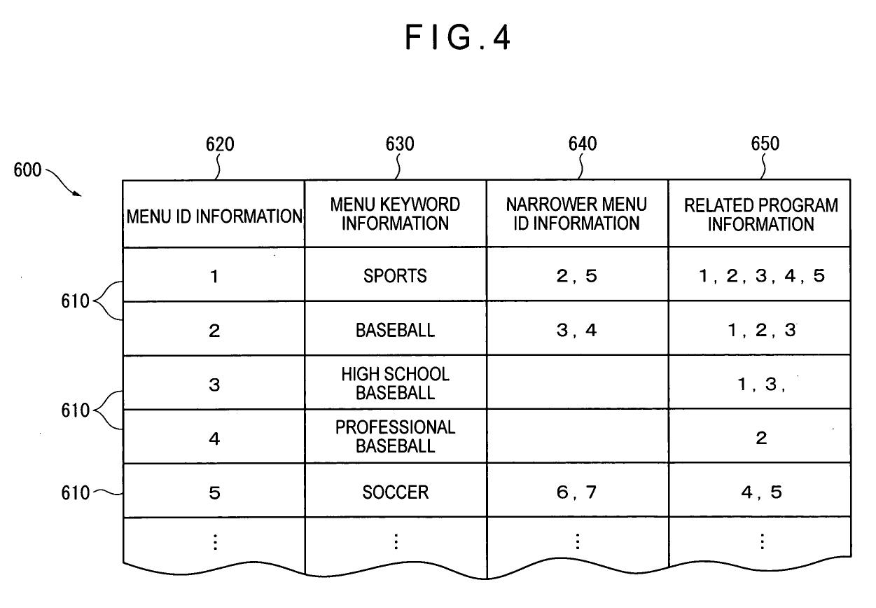

The memory 280 readably stores various information needed when desired content is acquired from the TS output from the communicator 210 to record the content or when the recorded content is reproduced. The memory 280 includes a menu storage area for storing menu index information 600 (classification criterion information database) as shown in FIG. 4 about operation information of the content. Note that the menu storage area may be arranged in the HDD 270. The memory 280 may include a drive or a driver that readably stores information in recording media as described above.

The menu index information 600 is information about a menu for classifying content which is set by the CPU 290. The menu index information 600 has a table structure containing plural pieces of menu information 610 (classification criterion information) that is structured in a single data structure with which menu ID information 620, menu keyword information 630 (detail criterion information), narrower menu ID information 640 and related program information 650 (information relation information) are associated. Note that the menu keyword information 630 and the related program information 650 form criterion information of the present invention.

The menu ID information 620 is ID information for identifying each menu information 610, the menu ID information 620 being, for instance, a number uniquely assigned to each menu information 610.

The menu keyword information 630 is information about a classification word for classifying content. The menu keyword information 630 is set by the CPU 290 based on the word information 530 of the classification dictionary 500. The narrower menu ID information 640 contains menu information 610 that has menu keyword information 630 containing a classification word of a narrower concept of the classification word contained in the menu keyword information 630 of the menu information 610. The narrower menu ID information 640 is set by the CPU 290 based on the narrower classification word information 540 of the classification dictionary 500. The narrower classification word information 540 contains, for instance, menu ID information 620 of subjected menu information 610. Note that the narrower menu ID information 640 may directly contain the menu keyword information 630 of the narrower concept.

The related program information 650 is information showing accumulated program information 410 that is classified by the menu information 610. The related program information 650 contains the program ID information 412 of the accumulated program information 410 containing the classification word that is contained in the menu keyword information 630.

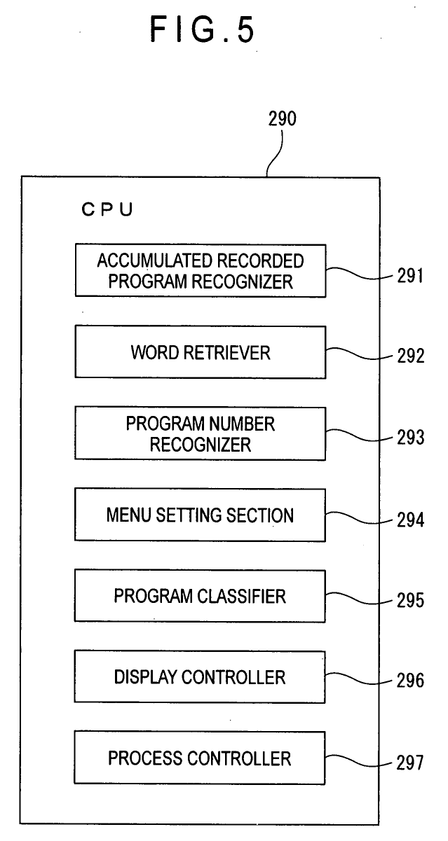

The CPU 290 is connected to various sections so as to control operations of the connected sections. As shown in FIG. 5, the CPU 290 includes: an accumulated recorded program recognizer 291 (detail information acquirer); a word retriever 292 also serving as a dictionary recognizer and a detail information recognizer; a program number recognizer 293 (related number information recognizer); a menu setting section 294 also serving as a criterion information generator, a classification criterion information generator, a detail information set generator, a broader detail information judging section and a data structuring section; a program classifier 295 also serving as a classification criterion acquirer, a related detail criterion information recognizer, a classifier, a related information number recognizer, a related number judging section, a replacing section and a classifier; a display controller 296; and a process controller 297.

The accumulated recorded program recognizer 291 recognizes the accumulated recorded program information 400 stored in the HDD 270.

The word retriever 292 recognizes the dictionary information 510 corresponding to a keyword contained in the accumulated program information 410 based on the accumulated program information 410 recognized by the accumulated recorded program recognizer 291 and the classification dictionary 500. Specifically, the word retriever 292 recognizes the accumulated program information 410 of the accumulated recorded program information 400 and extracts a keyword by a word basis from the program title information 415, the program genre information 416 and the program description information 417 of the accumulated program information 410. The word retriever 292 retrieves the word information 530 that contains a word substantially the same as the extracted keyword based on the classification dictionary 500. Then, the word retriever 292 acquires the dictionary information 510 containing this word information 530 and readably stores the word information 530 in the memory 280 as related word information KW as the detail information.

The program number recognizer 293 recognizes the number of pieces of accumulated program information related to a predetermined keyword. Specifically, the program number recognizer 293 recognizes the keyword contained in the word information 530 or the keyword contained in the menu keyword information 630 and recognizes the accumulated program information 410 in which the a detail substantially the same as the recognized keyword is contained program title information 415, the program genre information 416 or the program description information 417. Then, the program number recognizer 293 recognizes the number of the accumulated program information 410 that corresponds to the keyword out of the accumulated program information 410 contained in the accumulated recorded program information 400.

The menu setting section 294 generates the menu index information 600 based on the accumulated recorded program information 400 and the classification dictionary 500. Specifically, the menu setting section 294 recognizes the related word information KW retrieved by the word retriever 292, while the program number recognizer 293 recognizes the related program number as the number of the accumulated program information 410 associated with the related word information KW and programs related to the related word information KW. At this time, related program information is generated based on a program related to the recognized related word information Kw. The menu setting section 294 generates a related word set KWS (detail set information) as a set of the recognized related word information KW, recognizes related word information KWm of which the recognized related program number is minimum and generates a minimum word set MKW as a set of the recognized minimum related word information KWm. The menu setting section 294 readably stores the generated minimum word set MKW in the memory 280.

The menu setting section 294 recognizes broader related word information KWp (broader detail information) as a broader word of the related word information KWm contained in the minimum word set MKW based on the classification dictionary 500. Specifically, the menu setting section 294 recognizes the dictionary ID information 520 of the dictionary information 510 that corresponds to the related word information KWm contained in the minimum word set MKW and then retrieves the dictionary information 510 that contains the recognized dictionary ID information 520 in the narrower classification word information 540. When recognizing the broader related word information KWp as the broader word of the related word information KWm contained in the minimum word set MKW, the menu setting section 294 generates a broader word set PKW which is a set of the recognized broader related word information KWp. The menu setting section 294 readably stores the generated broader word set PKW in the memory 280.

The menu setting section 294 recognizes the related program number as the number of the accumulated program information related to each broader related word information KWp contained in the generated broader word set PKW. When the related program number is equal to or larger than a predetermined value (e.g., two), the menu setting section 294 adds to the related word set KWS the broader related word information KWp contained in the broader word set PKW and deletes from the related word set KWS related word information KWm that is contained in the minimum word set MKW as a narrower word of the added broader related word information KWp. In addition, the menu setting section 294 stores in the memory 280 the deleted related word information KWm in such a manner that the related word information KWm is associated with the broader related word information KWp as its narrower word information.

When judging that there is no broader related word information KWp as a broader concept of the related word information KWm contained in the minimum word set MKW, the menu setting section 294 generates the menu index information 600 based on the related word information KW contained in the related word set KWS. Specifically, the menu setting section 294 generates the menu keyword information 630 corresponding to the word information contained in this related word information KW, generates the narrower menu ID information 640 based on the narrower word information associated with this related word information KW and generates the related program information 650 based on the related program number recognized by the program number recognizer 293 and the related program information. The menu setting section 294 then associates the menu ID information 620 with these menu keyword information 630, narrower menu ID information 640 and related program information 650 to generate menu information. The menu setting section 294 stores the generated menu information 610 in the menu index information 600.

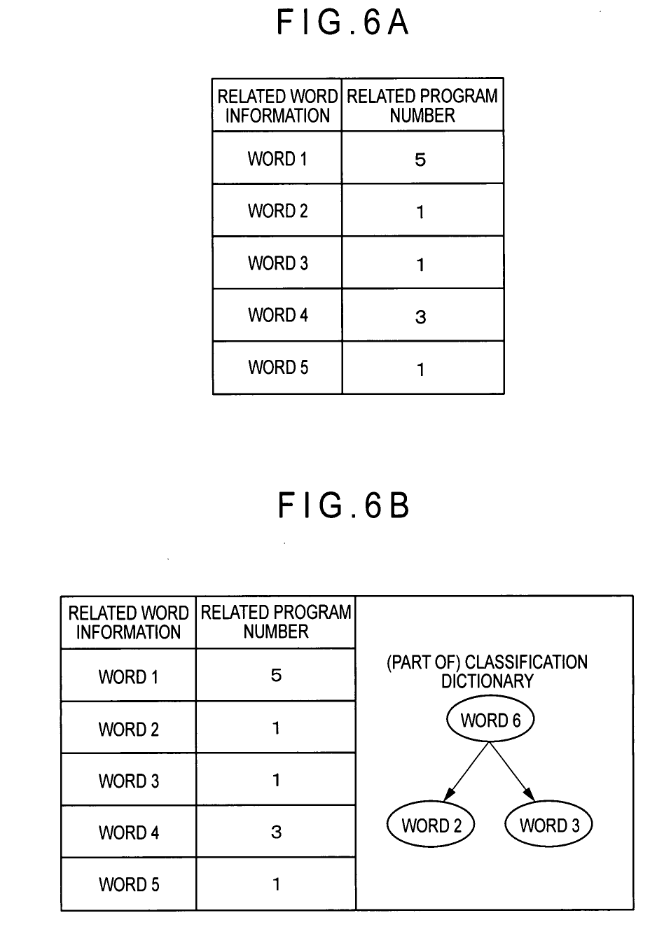

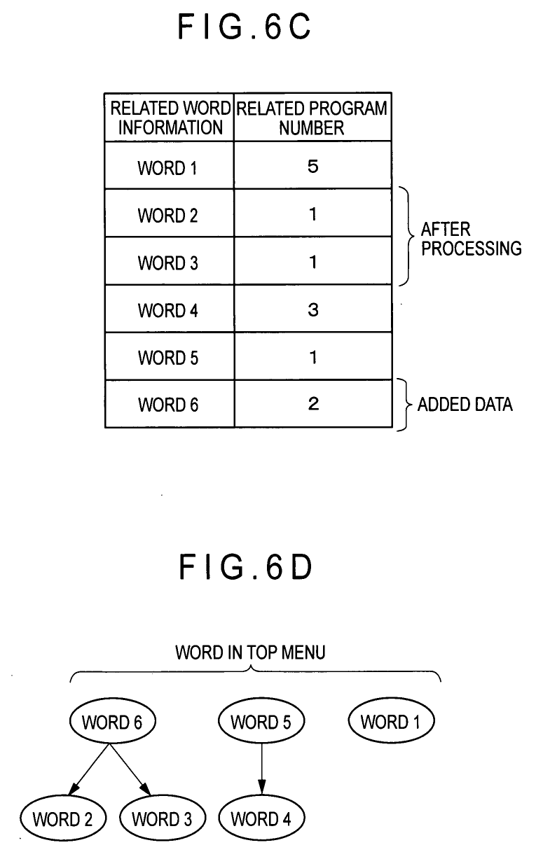

Now, the arrangement of the menu setting section 294 will be described with a concrete example as shown in FIG. 6. Suppose, for instance, the related word set KWS includes related word information KW containing Word 1 to Word 5 as shown in FIG. 6A. In such case, the menu setting section 294 generates a minimum word set MKW that includes related word information KW containing Word 1, Word 3 and Word 5 with the minimum related program number. When referring to the classification dictionary 500 and recognizing that the classification dictionary 500 contains Word 6 as a broader word of Word 2 and Word 3 as shown in FIG. 6B, the menu setting section 294 generates a broader word set PKW that includes related word information KW containing Word 6. Then, the menu setting section 294 recognizes the related program number of broader related word information KWp included in the broader word set PKW. When recognizing that the related program number of this broader related word information KWp is equal to or larger than a predetermined value (e.g., two), the menu setting section 294 adds the broader related word information KWp containing Word 6 to the related word set KWS as shown in FIG. 6C. The menu setting section 294 then deletes the related word information KWm containing Word 2 and Word 3 as narrower words of the broader related word information KWp from the related word set KWS. The menu setting section 294 stores the deleted related word information KWm in a manner associated with the broader related word information KWp as shown in FIG. 6D. The menu setting section 294 generates each menu information 610 with Word 1, Word 6 and Word 5 as top menu items (i.e., broadest related word information KW) and stores the generated menu information 610 in the menu index information 600.

The program classifier 295 acquires the menu index information 600 set by the menu setting section 294 and classifies recorded content substantially uniformly into each menu information 610 of the menu index information 600 based on details of the accumulated program information 410 such as the program title information 415, the program genre information 416 and the program description information 417. Specifically, the program classifier 295 recognizes the menu information 610 contained in the menu index information 600 as menu information Mi. Based on the related program information 650 of the menu information Mi, the program classifier 295 recognizes related program number PSi as the number of the accumulated program information 410 related to the menu information Mi.

The program classifier 295 then judges whether or not the related program information PSi is larger than a set value S that is preset. Note that the set value S may be preset or set by an input operation of a user. When judging that the related program number PSi is smaller than the set value S, the program classifier 295 judges whether there is broader menu information Mip as broader criterion information having a broader concept of the menu information Mi. Specifically, the program classifier 295 recognizes the menu ID information 620 of the menu information Mi and recognizes as broader menu information Mip menu information 610 having narrower menu ID information 640 that contains ID information of the recognized menu ID information 620 out of menu information 610 in the menu index information 600. The program classifier 295 classifies programs related to menu information Mi as narrower information of the recognized broader menu information Mip into the menu information Mip. Specifically, the program classifier 295 adds information contained in the related program information 650 of the menu information Mi to the related program information 650 of the broader menu information Mip. The program classifier 295 then deletes the menu information Mi as the narrower information of the broader menu information Mip from the menu index information 600.

When it is judged that the related program number PSi related to each menu information Mi is larger than the set value S or judged that the related program number PSi is smaller than the set value S and there is no broader menu information Mip as the broader concept of the menu information Mi, the program classifier 295 recognizes narrower menu information Mi_n as narrower criterion information of the menu information Mi to generate a narrower menu set MS containing the narrower menu information Mi_n. The program classifier then recognizes related program number PSi_n of the narrower menu information Mi_n contained in the generated narrower menu set MS based on the related program information and calculates an average value APS of the related program number PSi_n. Further, the program classifier 295 compares the calculated average value APS with the related program number PSi_n of each narrower menu information Mi_n. In this step, when judging that the related program number PSi_n is larger than the average value APS by a predetermined value (e.g., the related program number PSi_n is not less than twice as large as the average value APS), the program classifier 295 judges whether there is narrower menu information Mi_x having a second narrower menu information Mi_n_n (second classification criterion information) as a further narrower concept of the narrower menu information Mi_n. Specifically, the program classifier 295 recognizes the narrower menu ID information 640 of the narrower menu information Mi_n and recognizes menu information 610 that corresponds to ID information contained in the recognized narrower menu ID information 640. When judging that there is the second narrower menu information Mi_n_n, the program classifier 295 adds this second narrower menu information Mi_n_n as the narrower menu information Mi_n in the narrower menu set MS and deletes the narrower menu information Mi_x as a broader concept of the second narrower menu information Mi_n_n from the narrower menu set MS. As described above, the program classifier 295 modifies the menu information 610 such that the related program number of the related programs classified into the menu information 610 becomes substantially equal to the average value, thereby updating the menu index information 600.

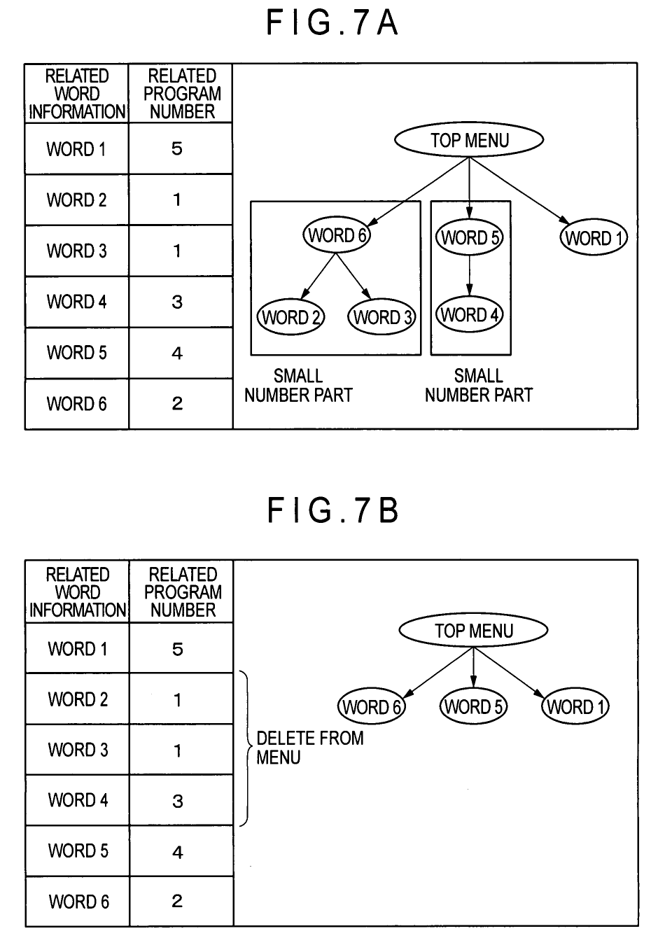

Now, the arrangement of the program classifier 295 will be described with a concrete example as shown in FIG. 7. When acquiring the menu index information 600 as shown in FIG. 7A which is set by the menu setting section 294, the program classifier 295 recognizes the related program number PSi to judge whether or not the related program number PSi is larger than a set value S (e.g., four). The program classifier 295 recognizes menu information Mi that contains Word 2, Word 3, Word 4 and Word 2 having related program number PSi smaller than the set value S as menu keyword information 630. As shown in FIG. 7B, the program classifier 295 recognizes the broader menu information Mip that corresponds to Word 6 as the broader concept of the menu information Mi corresponding to Word 2 and Word 3 and deletes the menu information Mi of Word 2 and Word 3. Similarly, the program classifier 295 recognizes menu information Mip that corresponds to Word 5 as a broader concept of menu information Mi corresponding to Word 4 and deletes the menu information Mi of Word 4.

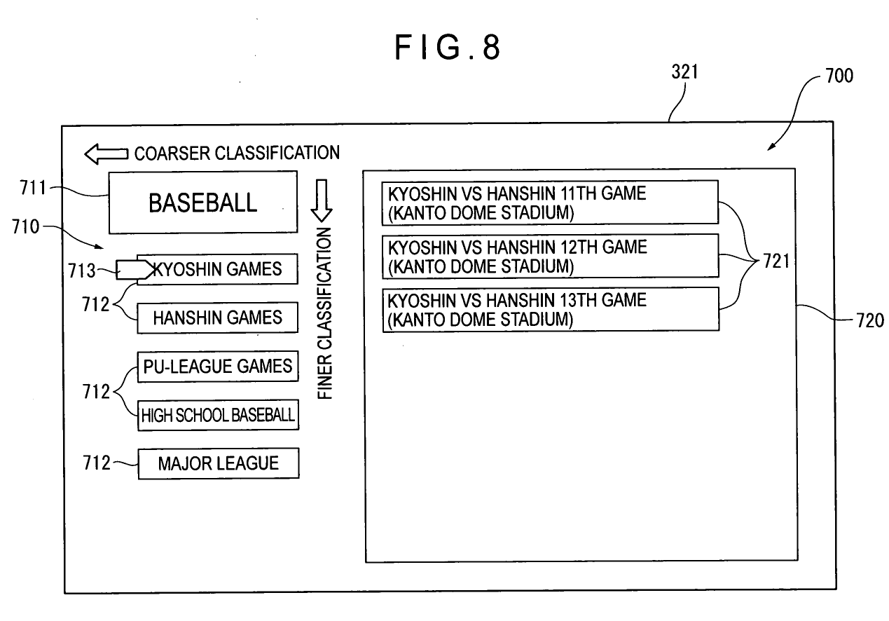

The display controller 296 sets and displays a program classification window 700 as shown in FIG. 8 in a display area 321 of the display unit 320 of the output device 300 based on the menu index information 600 updated by the program classifier 295.

Now, the program classification window 700 displayed in the display area 321 will be described. The program classification window 700 includes a menu item display area 710, a targeted program display area 720 and the like.

The menu item display area 710 is arranged, for instance, on a left part of the program classification window 700. The menu item display area 710 includes a broader menu display area 711, a narrower menu display area 712 and the like. The broader menu display area 711 is arranged above the menu item display area 710. The broader menu display area 711 displays menu keyword information 630 of predetermined menu information 610 contained in the menu index information 600. The narrower menu display area 712 is arranged below the broader menu display area 711. The narrower menu display area 712 displays vertically arranged menu keyword information 630 of menu information 610 corresponding to ID information in narrower menu ID information 640 of the menu information 610 displayed in the broader menu display area 711. Cursor information 713 for selecting one of plural pieces of the menu keyword information 630 is displayed near the one menu keyword information 630 out of the plural pieces of the menu keyword information 630 displayed in the broader menu display area 711 and the narrower menu display area 712.

The targeted program display area 720 is arranged on a right part of the program classification window 700. The targeted program display area 720 displays vertically arranged program title information 415 of accumulated program information 410 that corresponds to related program information 650 of the menu information 610 containing the menu keyword information selected by the cursor information 713.

The process controller 297 controls the communicator 210, the Demux 220 and the recording/reproduction processor 250 to receive content of a desired TV program and readably store the content in the HDD 270. Specifically, the process controller 297 stores content that is currently received and reproduced in response to an operation signal based on an input operation at the input section 260 or receives and stores content of which recording start time in timer recording information overlaps with the current time detected by the timer 298. The process controller 297 also controls the Demux 220, the decoder 230 and the recording/reproduction processor 250 to output content of a desired TV program to the output device 300 so as to be reproduced therein. Specifically, the process controller 297 reads the content from the HDD 270, decodes the content with the decoder 230 and outputs the content to the output device 300, the content identified by an operation signal based on an input operation at the input section 260 (e.g., by selecting a thumbnail from a list of thumbnails displayed on the output device 300) or the content set in advance as a so-called timer reproduction so as to be reproduced at a predetermined time.

[Operation of Recording/Reproduction System 100]

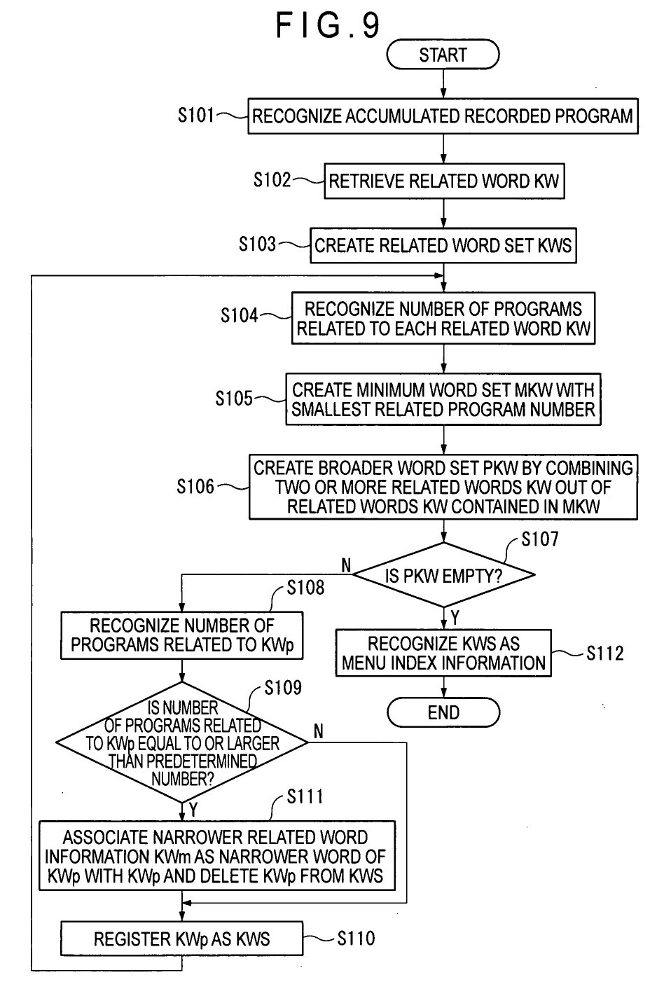

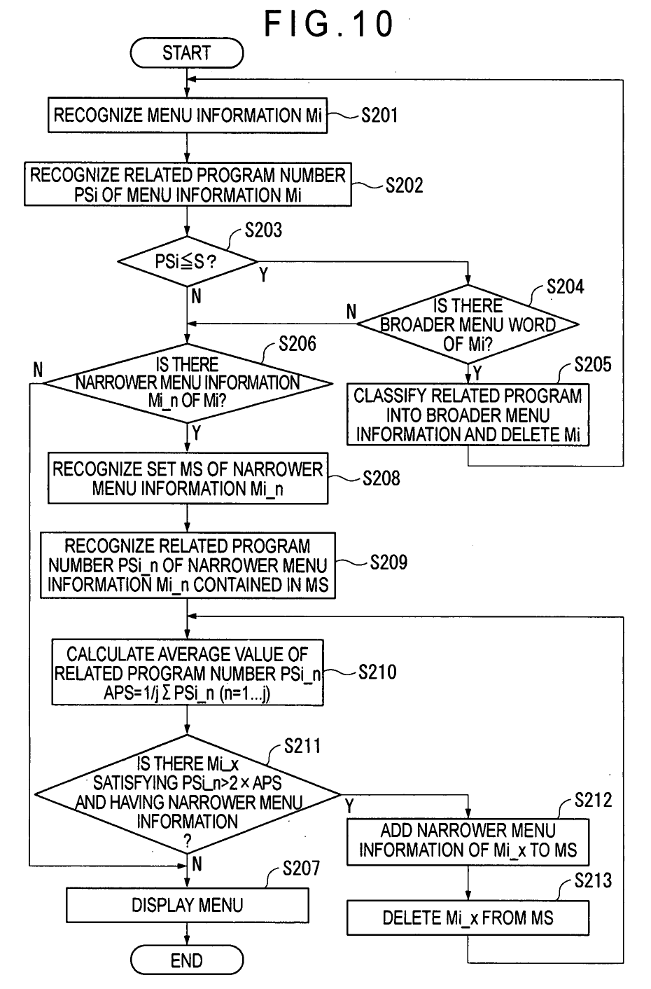

Next, an operation of the recording/reproduction system 100 will be described with reference to the drawings. FIG. 9 is a flowchart showing how the menu information is generated as menu generation processing in classification/display processing for classifying content into menus and displaying the content. FIG. 10 is a flowchart showing how the content is classified as classification processing in the classification/display processing in which the content is classified into the menus and displayed.

[Menu Generation Processing]

First, the menu generation processing will be described referring to FIG. 9. Specifically, description will be given with reference to FIG. 9 for the menu generation processing for generating menu information as classification criterions in the classification/display processing in which the content recorded in the HDD 270 of the recording/reproduction system 100 is classified and displayed.

When recognizing request information for requesting classification and display of content based on, for instance, an input operation of a user, the CPU 290 of the recorder/reproducer 200 recognizes the accumulated recorded program information 400 recorded in the HDD 270 (Step S101).

Then, the word retriever 292 of the CPU 290 recognizes the classification dictionary 500. The word retriever 292 extracts a keyword by a word basis from the program title information 415, the program genre information 416 and the program description information 417 of the accumulated program information 410 contained in the accumulated recorded program information 400 recognized in Step 101. The word retriever 292 then retrieves the dictionary information 510 that contains the word information 530 substantially the same as the extracted keyword (Step S102). Further, the word retriever 292 readably stores in the memory 280 the retrieved dictionary information 510 as the related word information KW.

Thereafter, the menu setting section 294 of the CPU 290 generates the related word set KWS containing a set of the related word information KW (Step S103). The menu setting section 294 readably stores the generated related word set KWS in the memory 280.

Next, the menu setting section 294 of the CPU 290 operates the program number recognizer 293 to recognize the related program number as the number of the accumulated program information 410 related to each related word information KW contained in the related word set KWS (Step S104).

The menu setting section 294 then recognizes the related word information KWm that has the minimum related program number from the related word set KWS based on the related program number recognized in Step S104. The menu setting section 294 generates the minimum word set MKW containing a set of the related word information KWm (Step S105).

Thereafter, the menu setting section 294 recognizes the dictionary ID information 520 of the dictionary information 510 corresponding to the recognized related word information KWm and recognizes the dictionary information 510 that includes the narrower classification word information 540 containing the ID information of this recognized dictionary ID information 520 as the broader related word information KWp. Then, the menu setting means 294 generates the broader word set PKW containing a set of the broader related word information KWp (Step S106).

Next, the menu setting section 294 judges whether or not the generated broader word set PKW is empty (Step S107).

When judging that the broader word set PKW is empty in Step S107, the menu setting section 294 generates the menu information 610 based on the related word information KW contained in the related word set KWS. The menu setting section 294 then stores the generated menu information 610 in the menu index information 600 (Step S108).

On the other hand, when judging that the broader word set PKW is not empty, the menu setting section 294 operates the program number recognizer 293 to recognize the related program number as the number of accumulated program information 410 related to the broader related word information KWp contained in the broader word set PKW (Step S109).

The menu setting section 294 then judges whether or not the related program number recognized in Step S109 is equal to or larger than a predetermined value (e.g., two) (Step S110).

When judging in Step S110 that the related program number recognized in Step S109 is smaller than the predetermined value, the menu setting section 294 registers the broader related word information KWp in the related word set KWS (Step S111).

On the other hand, when judging in Step S110 that the related program number recognized in Step S109 is equal to or larger than the predetermine number, the menu setting section 294 deletes the related word information KWm contained in the minimum word set MKW as the narrower concept of the broader related word information KWp from the related word set KWS. At the same time, the menu setting section 294 stores the deleted related word information KWm as menu information 610 associated with the related word information KWp as a narrower word of the broader related word information KWp (Step S112). Thereafter, the menu setting section 294 performs the process of Step S111. Specifically, the menu setting section 294 registers the broader related word information KWp in the related word set KWS.

[Content Classification Processing]

Next, the classification processing for classifying content as an operation of the recording/reproduction system 100 will be described referring to FIG. 10. Specifically, description will be given with reference to FIG. 10 for the classification processing for classifying content in the classification/display processing in which the content recorded in the HDD 270 of the recording/reproduction system 100 is classified and displayed.

The CPU 290 performs the classification processing for classifying the content after the menu generation processing shown in FIG. 9. First, the program classifier 295 of the CPU 290 acquires the menu index information 600 set by the menu setting section 294 and recognizes each menu information 610 contained in the menu index information 600 as the menu information Mi (Step S201).

Based on the related program information 650 of the menu information Mi, the program classifier 295 recognizes related program number PSi as the number of the accumulated program information 410 related to the menu information Mi (Step S202).

The program classifier 295 then judges whether or not the related program information PSi is larger than a set value S that is preset (Step S203).

When judging that the related program number PSi is smaller than the set value S in Step S203, the program classifier 295 judges whether there is broader menu information Mip having a broader concept of the menu information Mi (Step S204).

When judging that there is the broader menu information Mip as the broader concept of the menu information Mi in Step S204, the program classifier 295 classifies programs related to the menu information Mi as a narrower concept of the broader menu information Mip into the menu information Mip. The program classifier 295 then adds information contained in the related program information 650 of the menu information Mi to the related program information 650 of the broader menu information Mip and deletes the menu information Mi as the narrower concept of the broader menu information Mip form the menu index information 600 (Step S205).

When it is judged that the related program number PSi related to each menu information Mi is larger than the set value S in Step S203 or judged that the related program number PSi is smaller than the set value S and there is no broader menu information Mip as the broader concept of the menu information Mi in Step S205, the program classifier 295 judges whether there is narrower menu information Mi_n as a narrower concept of the menu information Mi (Step S206).

When it is judged that there is no narrower menu information Mi_n as the narrower concept of the menu information Mi in Step S206, the program classifier 295 completes update processing of the menu index information 600. The program classifier 295 classifies the programs into each menu information based on the details of the accumulated program information 410 such as the program title information 415, the program genre information 416 and the program description information 417. The display controller 296 of the CPU 290 displays the classified programs in the display area 321 as the program classification window 700 shown in FIG. 8 (Step S207).

On the other hand, when it is judged that there is the narrower menu information Mi_n as the narrower concept of the menu information Mi in Step S206, the program classifier 295 generates the narrower menu set MS containing the narrower menu information Mi_n (Step S208).

After Step S208, the program classifier 295 recognizes the related program number PSi_n of the narrower menu information Mi_n contained in the narrower menu set MS (Step S209).

Next, the program classifier 295 calculates the average value APS of the related program number PSi_n recognized in Step S209 (Step S210).

The program classifier 295 then compares the average value APS calculated in Step S210 with the related program number PSi_n of each narrower menu information Mi_n to judge whether there is narrower menu information Mi_x that has the related program number PSi_n of not less than twice as large as the average value APS and contains the second narrower menu information Mi_n_n as a further narrower concept of the narrower menu information Mi_n (Step S211).

When it is judged in Step S111 that there is the narrower menu information Mi_x that has the related program number PSi_n of not less than twice as large as the average value APS and contains the second narrower menu information Mi_n_n as the further narrower concept of the narrower menu information Mi_n, the program classifier 295 adds this second narrower menu information Mi_n_n as the narrower menu information Mi_n in the narrower menu set MS (Step S212).

The program classifier 295 deletes the narrower menu information Mi_x as the broader concept of the added second narrower menu information Mi_n_n from the narrower menu set MS (Step S213).

Thereafter, the CPU 290 again performs the process of Step S210. Specifically, the program classifier 295 calculates the average value APS of the related program number PSi_n.

On the other hand, when it is judged in Step S211 that there is no narrower menu information Mi_x having the related program number PSi_n of not less than twice as large as the average value APS or judged that there is no narrower menu information Mi_x having the second narrower menu information Mi_n_n as the further narrower concept of the narrower menu information Mi_n, the program classifier 295 completes the update processing of the menu index information 600. Thereafter, the CPU 290 performs the process of Step S207. Specifically, the display controller 296 displays the program classification window 700 as shown in FIG. 8 in the display area 321 based on the updated menu index information 600.

[Advantage of Recording/Reproduction System]

As described above, the recording/reproduction system 100 operates the word retriever 292 to retrieve the keyword from the accumulated program information 410 and operates the menu setting section 294 to recognize the related word information KW related to the retrieved keyword and to generate the menu index information 600 based on the recognized related word information KW. The program classifier 295 classifies content of a program based on the menu information Mi of the generated menu index information 600. With the arrangement, the program can be classified such that the related number of each menu information 610 becomes substantially equal, thus realizing proper classification of the program. Accordingly, concentration of many related programs on one of the menu information 610 can be avoided. Therefore, a user can easily check the programs classified into each menu information 610.

The menu information 610 contains plural pieces of criterion information 610A with which the menu keyword information 630 and the related program information 650 are associated, the plural pieces of criterion information 610A associated with the menu information 610 based on the narrower menu ID information 640. The program classifier then recognizes the related number PSi of programs related to the menu information Mi based on the related program information 650 and classifies the programs into the menu information Mi that has the related number PSi of not more than twice as large as the predetermined value APS. With the arrangement, the number of programs classified into one piece of the menu information 610 becomes not more than twice as large as the predetermined value APS, so that the number of programs classified into each menu information 610 becomes substantially equal. Accordingly, the programs can be properly classified.

When it is judged that the related number of the programs related to the menu information Mi is equal to or larger than the set value S in Step S203, the program classifier 295 recognizes the narrower menu information Mi_n as the narrower concept of this menu information Mi. The program classifier 295 then judges whether or not the related number PSi_n of the programs related to the narrower menu information Mi_n is equal to or larger than the predetermined value and performs processing such that the number of programs classified into each narrower menu information Mi_n becomes substantially equal. With the arrangement, when the related number of the menu information Mi is large, the program classifier 295 can acquire the narrower menu information Mi_n that can reduce this related number. Accordingly, by classifying the programs based on such narrower menu information Mi_n, the number of programs classified into one piece of narrower menu information Mi_n can be reduced. Thus, the programs classified into the menu information having too large related numbers can be classified into the narrower menu information Mi_n, thereby substantially equalizing the number of programs classified into each menu information.

When it is judged that the number of programs related to the menu information Mi is equal to or smaller than the set value S, the program classifier 295 judges whether or not there is broader menu information Mip as the broader concept of this menu information Mi. Then, when it is judged that there is the broader menu information Mip, the program classifier 295 classifies the related program information 650 of the menu information Mi into this broader menu information Mip and deletes the classified menu information Mi. With the arrangement, the menu information Mi having a small number of related programs is replaced by the menu information Mip having a large number of related programs, so that the related number of programs related to each menu information Mi can be substantially equalized.

When it is judged that the related number of programs related to the narrower menu information Mi_n is equal to or larger than the predetermined value in Step S211, the program classifier 295 recognizes the second narrower menu information Mi_n_n as the further narrower concept of this narrower menu information Mi_n and replaces the narrower menu information Mi_n with the second narrower menu information Mi_n_n. Accordingly, by dividing the narrower menu information Mi_n having too large related number into the second narrower menu information Mi_n_n, the related number of the menu information Mi_n having the large related number can be further reduced, thereby substantially equalizing the related number of programs related to each narrower menu information Mi_n.

At this time, the program classifier 295 calculates the average value APS of the related number of the narrower menu information Mi_n as the predetermined value and replaces the narrower menu information Mi_n having the related number of not less than twice as large as the average value APS with the second narrower menu information Mi_n_n. Accordingly, the related number of the programs related to the narrower menu information Mi_n can be brought closer to the average value APS, thereby substantially equalizing the related number of the programs related to each narrower menu information Mi_n.

In addition, by classifying the programs into the menu information 610 that corresponds to details of the accumulated program information 410, the number of programs classified into each menu information 610 can be substantially equalized. The display controller 296 displays the program classification window 700 as shown in FIG. 8 in the display area based on the updated menu index information 600. Accordingly, a user can easily check a desired program in the program classification window 700.

The menu setting section 294 operates the word retriever 292 to retrieve the related word information KW based on the accumulated program information 410 recognized by the accumulated recorded program recognizer 291. The menu setting section 294 recognizes the related number of programs related to the recognized related word information KW with the program number recognizer 293 and acquires the program related information. Then, the menu setting section 294 generates the criterion information 610A with which the recognized related word information KW and the program related information are associated. Then, the menu setting section 294 generates the menu information 610 with which the criterion information 610A of the menu keyword information 630 mutually associated by the narrower classification word information 540 is associated and generates the menu index information 600 containing plural pieces of the menu information 610. Accordingly, the menu information 610 about the details of the program can be easily generated using words contained in the accumulated program information 410, and the programs can be easily and properly classified using the menu index information 600 as described above.

When the broader related word information KWp as the broader concept of the related word information KW is recognized, the recognized broader related word information KWp is associated with the related word information KW. With the arrangement, relevance between each related word information KW can be easily recognized. Accordingly, the menu index information 600 can also be formed in a tree structure in which plural pieces of the menu information 610 are connected based on the relevance, so that the classification processing of the programs performed by the program classifier 295 can be facilitated.

The menu setting section 294 generates the related word set KWS containing a set of the related word information KW. When it is judged that there is the broader related word information KWp of the related word information KW, the menu setting section 294 registers the recognized broader word related word KWp in the related word set KWS. Accordingly, by sequentially registering the recognized broader related word information KWp in the related word set KWS, the menu setting section 294 can easily manage the related word information KW.

The word retriever 292 and the menu setting section 294 recognize the broader related word information KWp related to the related word information KW based on the classification dictionary 500. With the arrangement, the broader related word information KWp can be easily acquired.

The menu setting section 294 recognizes the related number of the programs related to the related word information KW. When judging that the related number of the programs related to the broader related word information KWp is equal to or larger than the predetermined value, the menu setting section registers the broader related word information KWp in the related word set KWS and deletes the related word information KWm that becomes the narrower concept of the registered broader related word information KWp from the related word set KWS while associating the related word information KWm with the broader related word information KWp. Specifically, when the related number of the programs related to the broader related word information KWp is small, this broader related word information KWp is not added as the related word set. With the arrangement, a situation where too many pieces of the menu information 610 are generated can be avoided, thus preventing the program classifier 295 from applying excessive load to the CPU 290 in performing processing based on the menu information 610.

The menu setting section 294 also generates the menu information 610 based on the related word information KWm associated as the narrower concept of the broader related word information KWp. With the arrangement, the program classifier 295 can classify program information more finely based on broader concepts and narrower concepts.

The menu setting section 294 associates the menu information 610 generated based on the broader related word information KWp with the menu information 610 generated based on the related word information KWm that is associated as the narrower concept of this broader related word information KWp. With the arrangement, the program classifier 295 can easily recognize broader menu information 610 that is a broader concept of the menu information 610.

### MODIFICATION OF EMBODIMENT

It should be noted that the present invention is not limited to the embodiment above but includes modifications shown below as long as an object of the present invention can be achieved.

Specifically, although the recorder/reproducer 200 that performs predetermined processing on content of a recorded program is exemplified in the embodiment above, the arrangement is not limited thereto. For example, as mentioned earlier, content of a radio program, a satellite broadcast program, distributed music or video, etc., various programs such as game software, various files recorded in a personal computer and the like may be employed as information subjected to the processing. For instance, when the various files recorded in the personal computer and the like are employed as the information, the information processing device extracts keywords based on extensions representing types of the files, details of the files, detail information such as related applications and the like. The information processing device recognizes a keyword as a broader concept and a keyword as a narrower concept of these extracted keywords and associates the keywords with each other. Then, the information processing device recognizes quantity of files related to the keywords and selects a keyword such that the numbers of files related to keywords of the narrowest concept in the association of the keywords become substantially equal. The information processing device generates directories related to the selected keyword and classifies the various files in the directories. By performing such processing on various types of information, when, for instance, predetermined information is desired to be retrieved from all information, the predetermined information can be easily found. When, for instance, image files classified substantially equally into the directories are displayed as thumbnails, reading of the image data can be smoothly performed due to the arrangement in which the number of the files classified into one directory is equal to or smaller than the preset number S, thereby reducing load applied on the CPU.

The accumulated recorded broadcast program recognizer 291 recognizes the accumulated program information 410 of the recorded content based on the EPG received by the communicator 210 in the embodiment above, but the arrangement is not limited thereto. Specifically, the accumulated recorded broadcast program recognizer 291 may directly recognize the EPG data and acquire the accumulated program information 410 of the recorded content. In the arrangement where the files recorded in the personal computer are employed as described above, the accumulated recorded broadcast program recognizer 291 may acquire detail information via a network such as the Internet.

Without limiting to the above-described arrangement in which the menu index information 600 is generated by the menu setting section 292, the menu index information may be acquired from the outside. Specifically, the menu index information 600 may be acquired by the communicator 210 as the classification criterion acquirer or may be acquired via a recording medium. In addition, any other arrangement for acquiring the menu index information 600 may be employed.

Although the related number of the programs related to the related word information KW is recognized by the program number recognizer 293 in the embodiment above, the arrangement is not limited thereto. For example, related number information about the related number of the programs related to the related word information KW may be acquired from the outside via a network or the like.

The program classifier 295 may recognize the narrower menu information Mi_n irrespective of the value of the related number PSi of the programs related to the menu information Mi. In such an arrangement, a set value S is not required.

Further, the program classifier 295 may recognize, irrespective of the value of related number PSi_n, the narrower menu information Mi_n as the narrower concept of the menu information Mi and the second narrower menu information Mi_n_n as the further narrower concept. Still further, the program classifier 295 may acquire all the menu information 610 having narrower concept of the narrower menu information Mi. In such arrangements, the program classifier 295 recognizes the related number related to the menu information 610, selects menu information having the optimal related number (e.g., the related number substantially equal to a limit number displayable in the program classification window 700) and classifies the programs into the selected menu information.

Although the program classifier 295 replaces the narrower menu information Mi_n with the second narrower menu information Mi_n_n in the embodiment above, the arrangement is not limited thereto. For example, acquired second narrower menu information Mi_n_n may be added.

Although the program classifier 295 recognizes the narrower menu information Mi_n having the related number PSi_n of larger than twice as large as the average value APS of the related number PSi_n of the programs related to the narrower menu information Mi_n and then recognizes the second narrower menu information Mi_n_n as the narrower concept of the recognized narrower menu information Mi_n in the embodiment above, the arrangement is not limited thereto. For example, the program classifier 295 may recognize the second narrower menu information Mi_n_n when the related number PSi_n is larger than a set value by a predetermined number. In the arrangement, the set value and the predetermined number may be set in advance, may be set arbitrarily by a user or may employ an average value of values that are arbitrarily set and accumulated by the user.

Although the program classified by the program classifier 295 is displayed in the program classification window 700 in the display area 321 of the display unit 320 in the embodiment above, the arrangement is not limited thereto. A display form is not limited to that of the program classification window 700. For example, it may be so arranged that the menu information 610 may be displayed in a tree structure, where when predetermined menu information 610 is selected by a user, a list of programs related to the selected menu information 610 is displayed. In addition, the program classified by the program classifier 295 may be output as sound from the sound output unit 310 instead of being displayed on the display unit 320.

Although the program classifier 295 recognizes the related number PSi based on the related program information 650 of the menu information 610 in the embodiment above, the program classifier 295 may operate the program number recognizer 293 to recognize the related number.

The related program information 650 may contain the program ID information 411 of the programs related to the menu information 610 as in the embodiment above or alternatively may contain a value of the related number of the programs related to the menu information 610.

The menu setting section 294 acquires the related word information KW related to the accumulated program information 410 based on the classification dictionary 500 in the embodiment above, but the arrangement is not limited thereto. For example, words contained in the program information 415, the program genre information 416 and the program description information 417 of the accumulated program information 410 are extracted and the extracted words may be used as the related word information KW.

Although the embodiment above is exemplified by the arrangement in which the broader related word information KWp as the broader concept of the related word information KW is recognized and the related word KW is associated with the broader related word KWp, the broader related word information KWp is not necessarily acquired.

The set value S compared with the related program number PSi by the program classifier 295 in Step S203 may be a value input by a user. Meanwhile, the number of program title information 415 to be displayed in the targeted program display area 720 of the program classification window 700 is determined by the set value S. Accordingly, by arranging such that the set value S is set desirably by the input of the user, the upper limit of the number of the program title information 415 to be displayed in the targeted program display area 720 can be arbitrarily selected.

When judging that the related program number PSi is larger than the set value S, the program classifier 295 may recognize the menu information 610 having the menu keyword information 630 that contains a word related to the menu keyword information 630 irrespective of the upper concept and narrower concept.

The recording/reproduction system 100 may determine the set value S by recognizing a display size of the display area 321 and calculating the set value S so as to meet the display size In such case, the CPU 290 preferably includes a display area recognizer that recognizes the size of the display area 321, a display amount recognizer that recognizes the number of the program title information 415 to be displayed and a value setting section that calculates the set value S. In such an arrangement, the display amount recognizer calculates a limit value of the program title information 415 displayable in a single window based on the size of the display area 321 recognized by the display area recognizer, a character font of the program title information 415 to be displayed and the like. Then, the value setting section sets the calculated limit value as the set value S. With the arrangement, the display controller 296 can display the program title information 415 in the single window in the targeted program display area 720 of the program classification window 700. Accordingly, a user does not have to operate a scroll bar or the like, so that the user can easily check desired program title information 415.

In the embodiment above, the menu setting section 294 generates the minimum word set MKW containing a set of the related word information KWm having the minimum related program number and recognizes the broader related word information KWp as the broader concept of at least two of the related word information KWm contained in the minimum word set, but the arrangement is not limited thereto. As an example, the menu setting section 294 may recognize the broader related word information KWp as the broader concept of at least two of the related word information KW contained in the related word set KWS.

As another example, the menu setting section 294 may extract a word contained in the accumulated program information 410 to generate the related word information KW and generate the menu information from only these generated related word information KW. In such case, the menu setting section 294 may recognize relevance of these related word information KW based on the classification dictionary 500 and associate the menu information 610 with each other in accordance with the relevance of the related word information KW.

In the embodiment above, when the related number of the programs related to the broader related word information KWp is judged to be equal to or larger than a predetermined value in Step S109, this broader related word information KWp is registered in the related word set KWS, but the arrangement is not limited thereto. The broader related word information KWp recognized in Step S106 may be registered in the related word set KWS irrespective of the related number of the broader related word information KWp.

In the embodiment above, when the program number PSi related to the menu information Mi is judged to be equal to or smaller than the set value S in Step S203, the broader menu information Mip is recognized and the menu information Mi is replaced by the recognized broader menu information Mip. However, the arrangement is not limited thereto. For example, it may be so arranged that the process of Step S206 is performed even when the program number PSi related to the menu information Mi is equal to or smaller than the set value S.

### ADVANTAGE OF EMBODIMENT

As described above, the word retriever 292 retrieves the keyword from the accumulated program information 410 while the menu setting section 294 recognizes the related word information KW related to the retrieved keyword and generates the menu index information 600 based on the recognized related word information KW. The program classifier 295 classifies content of a program based on the menu information Mi of the generated menu index information 600. With the arrangement, the program can be classified such that the related number of each menu information 610 becomes substantially equal, thus realizing proper classification of the program.

### INDUSTRIAL APPLICABILITY

The present invention is applicable to an information processing device that processes information, a classification criterion information database, an information generating device, an information processing method, an information generating method, an information processing program and a recording medium storing the information processing program.

1. An information processing device, comprising:
a detail information acquirer that acquires detail information about a detail of information;
a classification criterion acquirer that acquires classification criterion information about a classification criterion into which the information is classified;
a related information number recognizer that recognizes related number of information related to the classification criterion information;
a related number judging section that judges where the related number is equal to or larger than a predetermined set value;
a display controller that controls a display section to display the classified information;
a display area recognizer that recognizes a size of a display area of the display section;
a display amount recognizer that recognizes a limit of the number of pieces of the information displayable on the display section based on the size of the display area;
a value setting section that sets the set value so as to be equal to or smaller that the limit, and
a classifier that classifies, based on the detail of the detail information and a judgment result of the related number judging section, the information into the classification criterion information corresponding to the detail of the information such that the related number becomes substantially equal.

2. The information processing device according to claim 1, wherein
the classification criterion information has a structure with which plural pieces of criterion information are associated, the criterion information associated with detail criterion information about a classification criterion corresponding to the detail of the detail information and related number information about the related number related to the detail criterion information,
the related information number recognizer recognizes related number of the information based on the related number information,
the classifier classifies the information into criterion information corresponding to the detail of the detail information and having the related number of equal to or smaller than the set value in order to substantially equalize the related number of the information classified into the criterion information.

3. The information processing device according to claim 2, wherein
the related number judging section judges whether or not the related number of related to the detail criterion information is equal to or larger than the set value; and
the information processing device further includes a related detail criterion information recognizer that recognizes, when it is judged that the related number is equal to or larger than the set value, at least two pieces of another detail criterion information that are associated with the detail criterion information, wherein
the classifier classifies the information into criterion information corresponding to the at least two pieces of another criterion information.

4. The information processing device according to claim 3, wherein the related detail criterion information recognizer recognizes narrower criterion information that corresponds to narrower detail information about a detail of a narrower concept of the detail criterion information.

5. The information processing device according to claim 3, wherein
when the related number judging section judges that the related number of the information related to the detail criterion information is equal to or smaller than the set value, the related detail criterion information recognizer recognizes broader criterion information that corresponds to detail information of a broader concept of the detail information corresponding to the classification criterion information, and
the information processing device further includes a replacing section that replaces the criterion information corresponding to the detail criterion information with criterion information corresponding to the broader criterion information.

6. The information processing device according to claim 3, wherein
when the related number of the information related to the narrower criterion information is equal to or larger than a predetermined value, the related detail criterion information recognizer recognizes second narrower criterion information that corresponds to second narrower detail information of a narrower concept of the narrower detail information corresponding to the narrower criterion information, and
the replacing section replaces criterion information corresponding to the narrower criterion information with criterion information corresponding to the second narrower criterion information.

7. The information processing device according to claim 6, wherein the predetermined value is an average value of related numbers of the information related to the narrower criterion information.

8. The information processing device according to claim 1, wherein the detail information acquirer acquires detail information about a detail of distributed information.

9. A classification criterion information database, comprising:
plural pieces of classification criterion information that are structured in a table, each of the classification criterion information associated with plural pieces of criterion information, each of the criterion information associated with: detail criterion information about a classification criterion that corresponds to detail information about a detail of information and classifies the information; and related number information about related number of information related to the detail criterion information.

10. An information generating device, comprising:
a detail information recognizer that recognizes first detail information about a first detail of information and second detail information about a second detail related to the first detail of the first detail information;
a related number information recognizer that recognizes related number information about related number of the information related to the first detail information; and
a criterion information generator that generates first criterion information with which the first detail information and the related number information corresponding to the first detail information are associated;
a classification criterion information generator that associates the first criterion information with second criterion information having the second detail information of the second detail related to the first detail of the first detail information of the first criterion information; and
a data structuring section that structures classification criterion information database containing plural pieces of classification criterion information that are structured in a table, each of the classification criterion information associated with plural pieces of criterion information, each of the criterion information associated with: detail criterion information about a classification criterion that corresponds to detail information about a detail of information and classifies the information; and related number information about related number of information related to the detail criterion information.

11. The information generating device according to claim 10, wherein
the data structuring section associates broader criterion information based on broader detail information of a broader concept of the detail of the detail information corresponding to the detail criterion information with the detail criterion information.

12. The information generating device according to claim 11, further comprising:
a detail information set generator that generates detail set information containing a set of plural pieces of the detail criterion information; and
broader detail information judging section that judges whether there is broader detail information related to a detail of a broader concept of detail information that corresponds to at least two pieces of detail criterion information in the plural pieces of detail criterion information as a component of the detail set information, wherein
when the broader detail information judging section judges that there is the broader detail information, the classification criterion information generator adds broader detail criterion information corresponding to the broader detail information to the detail set information.

13. The information generating device according to claim 12, further comprising:
a dictionary recognizer that recognizes detail relation dictionary information with which plural pieces of detail criterion information are associated, wherein
the detail information recognizer recognizes the broader detail information related to the detail information based on the detail relation dictionary information.

14. The information generating device according to claim 10, wherein
when a number in the related number information corresponding to the broader detail information is equal to or larger than a predetermined value, the classification criterion information generator generates detail criterion information with which narrower detail information as a narrower concept of the broader detail information is associated and adds the generated detail criterion information to the detail information set while deleting the narrower detail information as the narrower concept of the broader detail information from the detail set information.

15. The information generating device according to claim 10, wherein
the data structuring section associates the detail criterion information based on the detail information associated as the narrower concept of the broader detail information with the broader detail information as narrower criterion information as a narrower concept of the detail criterion information based on the broader detail information.

16. The information processing device according to claim 1, wherein the classifier classifies the information into criterion information of the classification criterion information of an information generating device the information generating device including:
a detail information recognizer that recognizes first detail information about a first detail of information and second detail information about a second detail related to the first of the first detail information;
a related number information recognizer that recognizes related number information about related number of the information related to the first detail information; and
a criterion information generator that generates first criterion information with which the first detail information and the related number information corresponding to the first detail information are associated;
a classification criterion information generator that associates the first criterion information with second criterion information having the second detail information of the second detail related to the first detail of the first detail information of the first criterion information; and
a data structuring section that structures classification criterion information database containing plural pieces of classification criterion information that are structured in a table, each of the classification criterion information associated with plural pieces of criterion information, each of the criterion information associated with: detail criterion information about a classification criterion that corresponds to detail information about a detail of information and classifies the information; and related number information about related number of information related to the detail criterion information.

17. An information processing method, comprising:
acquiring detail information about a detail of information;
acquiring classification criterion information about a classification criterion into which the information is classified;
recognizing related number of information related to the classification criterion information, judging whether the related number is equal to or larger than a predetermined set value;
recognizing a size of a display area that displays the classified information;
recognizing a limit of the displayable number of pieces of the information based on the size of the display area; and
setting the value so as to be equal to or smaller than the limit
classifying, based on the detail of the detail information the information and a judgment result about the related number, into the classification criterion information corresponding to the detail of the information such that the related number becomes substantially equal.

18. An information generating method, comprising:
recognizing first detail information about a first detail of information and second detail information about a second detail related to the first detail of the first detail information;
recognizing related number information about related number of the information related to the first detail information;
generating first criterion information with which the first detail information and the related number information corresponding to the first detail information are associated;
associating the first criterion information with second criterion information having the second detail information of the second detail related to the first detail of the first detail information of the first criterion information; and
structuring classification criterion information containing plural pieces of the classification criterion information that are structured in a table, each of the classification criterion information associated with plural pieces of criterion information, each of the criterion information associated with: detail criterion information about a classification criterion that corresponds to detail information about a detail of information and classifies the information; and related number information about related number of information related to the detail criterion information.

19. An information processing program that operates a computing section as an information processing device that includes:
a detail information acquirer that acquires detail information about a detail of information;
a classification criterion acquirer that acquires classification criterion information about a classification criterion into which the information is classified:
a related information number recognizer that recognizes related number of information related to the classification criterion information;
a related number judging section that judges whether the related number is equal to or larger than a predetermined set value;
a display controller that controls a display section to display the classified information;
a display area recognizer that recognizes a size of a display area of the display section;
a display amount recognizer that recognizes a limit of the number of pieces of the information displayable on the display section based on the size of the display area;
a value setting section that sets the set value so as to be equal to or smaller than the limit; and
a classifier that classifies, based on the detail of the detail information and a judgment result of the related number judging section, the information into the classification criterion information corresponding to the detail of the information such that the related number becomes substantially equal.

20. An information processing program that operates a computing section to perform an information processing method that includes:
acquiring detail information about a detail of information;
acquiring classification criterion information about a classification criterion into which the information is classified;
recognizing related number of information related to the classification criterion information;
judging whether the related number is equal to or larger than a predetermined set value;
recognizing a size of a display area that displays the classified information;
recognizing a limit of the displayable number of pieces of the information based on the size of the display area, and
setting the value so as to be equal to or smaller than the limit
classifying, based on the detail of the detail information the information and a judgment result about the related number, into the classification criterion information corresponding to the detail of the information such that the related number becomes substantially equal.

21. A recording medium that stores an information processing program in a manner readable by a computing section, the program operating the computing section as an information processing device that includes:
a detail information acquirer that acquires detail information about a detail of information;
a classification criterion acquirer that acquires classification criterion information about a classification criterion into which the information is classified;
a related information number recognizer that recognizes related number of information related to the classification criterion information;
a related number judging section that judges whether the related number is equal to or larger than a predetermined set value;
a display controller that controls a display section to display the classified information;
a display area recognizer that recognizes a size of a display area of the display section;
a display amount recognizer that recognizes a limit of the number of pieces of the information displayable on the display section based on the size of the display area;
a value setting section that sets the set value so as to be equal to or smaller than the limit; and
a classifier that classifies, based on the detail of the detail information and a judgment result of the related number judging section, the information into the classification criterion information corresponding to the detail of the information such that the related number becomes substantially equal.

22. A recording medium that stores an information processing program in a manner readable by a computing section, the program operating the computing section to perform an information processing method that includes:
acquiring detail information about a detail of information;
acquiring classification criterion information about a classification criterion into which the information is classified;
recognizing related number of information related to the classification criterion information;
judging whether the related number is equal to or larger than a predetermined set value;
recognizing a size of a display area that displays the classified information;
recognizing a limit of the displayable number of pieces of information based on the size of the display area; and
setting the set value so as to be equal to or smaller than the limit
classifying, based on the detail of the detail information the information and a judgment result about the related number, into the classification criterion information corresponding to the detail of the information such that the related number becomes substantially equal.

23. (canceled)
